(19) United States
(12) Patent Application Publication
(10) Pub. No.: US 2005/0207688 A1
(43) Pub. Date: Sep. 22, 2005

(54) Radial roller bearing

(75) Inventor: Klaus Dannhoff, Bielefeld (DE)

Correspondence Address: MICHAEL BEST & FRIEDRICH, LLP, 100 E WISCONSIN AVENUE, MILWAUKEE, WI, 53202, US

(73) Assignee: TIMKEN GmbH, Halle (DE)

(21) Appl. No.: 11/070,949

(22) Filed: Mar. 3, 2005

(30) Foreign Application Priority Data
Mar. 16, 2004 (DE) 10 2004 012 806.5

(51) Int. Cl. F16C 33/48

(52) U.S. Cl. 384/523

(57) ABSTRACT

A radial roller bearing with a roller crown of cylindrical roller members (13) adjacent to each other between which distance pieces (15) each are inserted at which the roller members (13) are guided. The roller members (13) further are guided in windows (21) of an outer partial cage (11) which has only two cage side rims (17) and webs (19) arranged between the windows (21).

### BACKGROUND

The present invention relates to a radial roller bearing. More particularly, the present invention relates to a radial roller bearing with a roller crown of cylindrical roller members adjacent to each other, between which individual intermediate pieces are inserted, the intermediate pieces having contact surfaces on both sides at which the roller members are guided.

Such a radial roller bearing is known from DE 196 05 743 A1. Therein there are arranged between a solid bearing inner ring and a solid bearing outer ring cylindrical roller members between each of which individual intermediate pieces are inserted having on both sides contact surfaces at which the roller members are guided.

A radial roller bearing with such a roller crown has the advantage that the roller members do not contact each other neither in the non-operating condition nor during rotation, whereby thus friction, heating and wear are reduced. Such a “full crown” radial roller bearing thus has a high bearing capacity. Thus, in this prior art there is a combination of the positive characteristics of a full crown bearing with those of a bearing provided with a bearing cage. Herein it is disadvantageous that the bearing due to the solid inner and outer rings requires a great radial overall height and consequently has a considerable weight.

### SUMMARY

The invention is based on the object to reduce the radial overall height of the bearing and thereby to obtain a considerable saving in material and weight.

This is achieved by a radial roller bearing comprising a plurality of cylindrical roller members adjacent to each other with a space therebetween. An intermediate piece is positioned in each space, each intermediate piece having contact surfaces on both sides thereof at which the roller members are guided. An outer partial cage including a pair of spaced apart radially extending cage side rims with a plurality of spaced apart webs extending between the side rims to define windows is provided such that the roller members are positioned in the windows and radially constrained by the outer partial cage.

Thus, in an advantageous manner, solid inner or outer rings are not used. An inner ring is omitted completely. Already hereby there results a considerable reduction of the radial overall height with a corresponding saving in material and weight.

Also, a full or solid outer ring is not used, but only a so-called partial cage with cage webs and windows provided therebetween, whereby a further reduction in material and weight is obtained. The retention of the roller members towards the outside is obtained solely by the cage webs and towards the inside solely by the intermediate pieces between the roller members.

Further details and advantages of the invention result from the following description of an embodiment in connection with the drawings.

### BRIEF DESCRIPTION OF THE DRAWINGS

FIG. 1 shows schematically a radial roller bearing according to a first embodiment of the invention in a perspective view.

FIG. 2 is a radial section through the radial roller bearing of FIG. 1, seen in axial direction.

FIG. 3 is a perspective view of the partial cage of the radial roller bearing of FIG. 1.

FIG. 4 shows the arrangement of the roller members or rollers of the roller bearing of FIG. 1.

FIG. 5 shows the arrangement of the intermediate pieces of the roller bearing of FIG. 1.

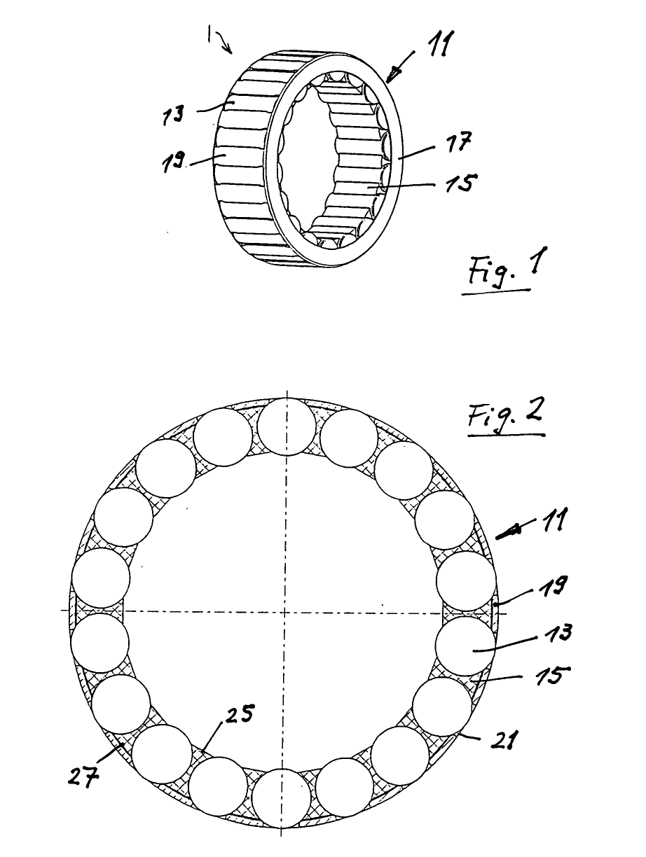

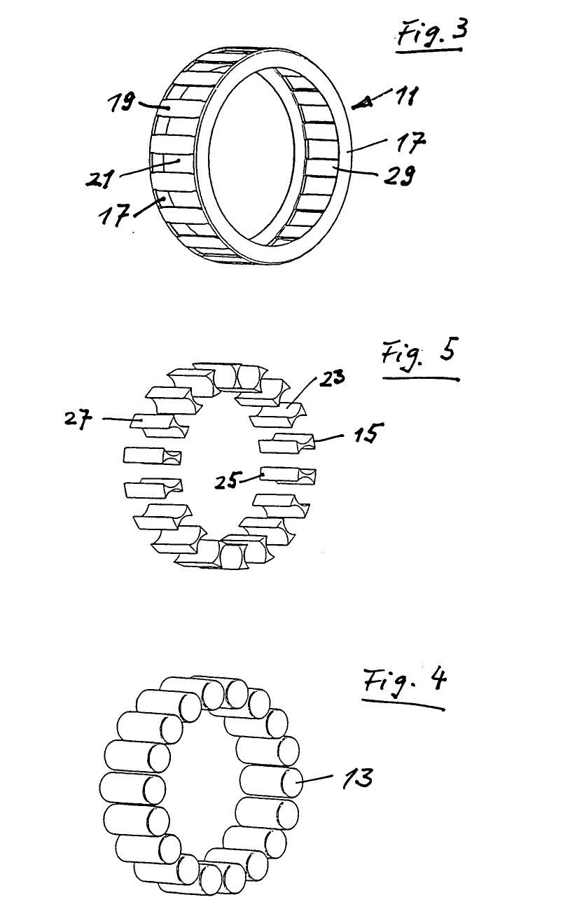

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”,“rear” and “rearward”, is used in the following description for relative descriptive clarity only and is not intended to be limiting.

The radial roller bearing 1 according to a preferred embodiment of the present invention comprises substantially three components, namely an outer partial cage 11, cylindrical roller members or rollers 13 guided therein, and distance pieces or intermediate pieces 15 arranged between the rollers 13.

The partial cage 11 has provided at its axial ends two cage end rims 17 which are rigidly connected with each other by radially outer cage webs 19 arranged therebetween. Between the webs 19 there are provided cage windows 21.

The rollers 13 arranged within the cage 11 extend with their outer sides or outer circumferences outwardly through the windows 21 in order to be able to contact an outer bearing race (not shown). At the radially inner side the circumferences of the rollers 13 extend inwardly beyond the intermediate pieces 15 in order to be able to roll on a radially inner race (not shown). The roller retention, thus, on the outer side is achieved only by the webs 19 in connection with the windows 21 and by the intermediate pieces 15 and on the inner side solely by the intermediate pieces 15.

Thus, there is a radial roller bearing 1 with a roller crown with the greatest possible number of cylindrical roller members, needles or rollers 13 adjacent to each other between each of which individual intermediate pieces 15 are arranged. The intermediate pieces 15 have in circumferential direction at their both sides contact surfaces 23, the curvature of which corresponds to that of the rollers 13 and on which the rollers 13 roll and are guided in circumferential direction. Further, the roller members or rollers 13 are guided in a radially outward direction in the windows 21 between the webs 19 of the cage 11.

Since no full or solid inner or outer rings are used, there results a small radial overall height which is utilized alone by the diameter of the rollers 13. Thus, there results a corresponding saving in material and weight, and roller members 13 with comparatively large diameter can be used for achieving a high load capacity of the bearing.

The intermediate pieces 15 at their radially inner side 25 are broader in circumferential direction than the smallest distance between adjacent rollers 13, so that these are retained radially inwardly only by the distance pieces or intermediate pieces 15.

At their radially outer sides 27 the distance pieces 15 can be broader in circumferential direction than at their radially inner sides 25, so that also at the outer side a good radial guidance of the rollers 13 is given.

In an advantageous manner, the intermediate pieces 15 with their radial outer side 27 can contact at the inner side 29 of the cage webs 19. Thus, there results a particularly good support and retention of the roller members 13 or the roller crown in an outward direction.

Finally, the distance pieces or intermediate pieces 15 can be made of suitable synthetic materials, whereby good rolling characteristics between the rollers 13 and the intermediate pieces 15 are given and the bearing altogether becomes still lighter as compared to the use of metal.

The rollers 13 contact the intermediate pieces 15 only with their own circumferential speed, so that with a corresponding pairing of metal and plastics there result favorable running characteristics. The rollers 13 do not contact each other, so that thereby the friction and heating cannot occur which is given with a direct contact of the rollers by a duplication of their circumferential speed.

All together, the bearing of the invention has the load carrying capacity or load carrying number of a full-crown bearing with a low radial overall height and a corresponding low weight.

1. A radial roller bearing comprising:
a plurality of cylindrical roller members adjacent to each other with a space therebetween;
an intermediate piece inserted in each space, each intermediate piece having contact surfaces on both sides thereof at which the roller members are guided; and
an outer partial cage including a pair of spaced apart radially extending cage side rims with a plurality of spaced apart webs extending between the side rims to define windows such that the roller members are positioned in the windows and radially constrained by the outer partial cage.

2. A radial roller bearing according to claim 1, wherein each space defines a minimum circumferential distance between the rollers and wherein each intermediate piece has a radially inner edge that is circumferentially broader than the minimum circumferential distance.

3. A radial roller bearing according to claim 1, wherein each space defines a minimum circumferential distance between the rollers and wherein each intermediate piece has a radially outer edge that is broader than the minimum circumferential distance.

4. A radial roller bearing according to claim 1, wherein each web has an inner surface and each intermediate piece has a radially outer edge in contact the web inner surfaces.

5. A radial roller bearing according to claim 1, wherein the intermediate pieces are made of synthetic material.
